(19) United States
(12) Patent Application Publication
(10) Pub. No.: US 2016/0121678 A1
(43) Pub. Date: May 5, 2016

(54) Suspension Member for a Motor Vehicle and Method of Making Same

(71) Applicant: Ford Global Technologies, LLC, Dearborn, MI (US)

(72) Inventors: Christoph Meier, Koln (DE); Peter Kurbel, Overath (DE)

(73) Assignee: Ford Global Technologies, LLC, Dearborn, MI (US)

(21) Appl. No.: 14/932,163

(22) Filed: Nov. 4, 2015

(30) Foreign Application Priority Data
Nov. 5, 2014 (DE) 10214222575.2
Nov. 5, 2014 (DE) 102014222576.0

(51) Int. Cl. B60G 7/00; B21D 53/88; B60G 3/06

(52) U.S. Cl. CPC B60G 7/005; B60G 3/06; B60G 7/001; B21D 53/88

(57) ABSTRACT

A control arm or transverse link having a ball joint seat for receiving a press-fit ball joint. The material of a portion of the ball joint seat in a region provided for press-fit contact with the ball joint having a reduced material thickness. A method for producing the control arm or transverse link includes reducing a wall thickness of the ball joint seat by deformation or material severing.

### CROSS-REFERENCE TO RELATED APPLICATIONS

Not Applicable.

### BACKGROUND OF THE INVENTION

1. Field of the Invention

The present invention relates to a suspension member for a motor vehicle; and, more specifically, to a suspension member having a structure for receiving a ball joint.

2. Description of Related Art

Wheel suspension arrangements connect vehicle wheels to the chassis or to the self-supporting body of a motor vehicle. Individual wheel suspension arrangements, in contrast to rigid axles, are composed of separate wheel suspension arrangements on the two sides of a motor vehicle, such that the wheel positions on the two sides do not influence one another. Wheel suspension arrangements are typically constructed from so-called control arms or links that fix the wheels horizontally to the chassis or body. Here, control arms or transverse links are major constituent parts of wheel suspension arrangements, in particular of front-wheel suspension arrangements. In one example, a control arm or transverse link is installed transverse the direction of travel. A typical form of a control arm or transverse link is a single-shell triangular member having two connecting arms are connected by way of rubber bearings to the body, and one connecting arm, connected by way of a joint, typically a ball joint, to a wheel carrier of a wheel.

Ball joints absorb forces from multiple directions and transmit forces in multiple directions. Ball joints typically include a joint pin, on one end of which there is formed a ball, a shell which receives the ball of the pin, and a joint housing which accommodates the shell and parts of the ball pin. The ball of the ball pin slides in the prestressed, permanently lubricated shell protected against moisture and dirt by the housing.

The connection of the ball joint housing to a corresponding control arm or transverse link may be realized, for example, by way of a press-fit connection, a welded connection, a screw connection, a rivet connection and the like. A press-fit connection, realized by friction locking, is a low cost variant. However, a press-fit connection a greater space requirement in relation to other connection types do to the material thickness of the wall of the press-fit seat and the resulting large bend radius of the material. The press-fit seat is typically a deep-drawn cylinder in the material of the link whereby a press-fit ball joint must inevitably be arranged further to the inside in relation to the vehicle dimensions than with other methods. This has an adverse effect on the steering characteristics of the vehicle, as the steering offset is not optimally configured.

### SUMMARY OF THE INVENTION

A first example of the invention is a suspension member including a link having a material thickness and a ball joint seat. The ball joint seat includes a flange wherein the flange includes a wall having an inner side. The flange has a material thickness wherein the material thickness of the flange is smaller than the material thickness of the link.

Furthermore, a method of forming a suspension member for a motor vehicle is disclosed, in particular, a control arm or transverse link. The method includes providing a metal sheet having an initial material thickness as a starting material. Providing a tool and using the tool to cut a shape from the respective metal sheet corresponding to the basic shape of the suspension member. Deforming the metal sheet to form the suspension member including forming a ball joint seat in the suspension member wherein the ball joint seat includes a flange. Removing material from an inner side of the flange in a region provided for press-fit contact with a ball joint.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a partial perspective view of an exemplary embodiment of a control arm or transverse link having a press fit ball joint located in an exemplary embodiment of a ball joint seat according to the present invention.

FIG. 2 shows a partial cross-sectional view of a control arm or transverse link having a press-fit ball joint located in the ball joint seat according to the present invention adjacent a wheel assembly.

FIG. 3 shows an enlarged partial cross-sectional view of a press-fit ball joint located in the ball joint seat according to the present invention.

FIG. 4 shows a cross-sectional view of an exemplary embodiment of the ball joint seat of FIG. 1 after an initial forming step.

FIG. 5 shows a cross-sectional view of an exemplary embodiment of the ball joint seat of FIG. 4 after a further forming step.

FIG. 6 shows a cross-sectional view of an exemplary embodiment of the ball joint seat of FIG. 5 after a further forming step.

FIG. 7 shows a cross-sectional view of a ball joint seat and press-fit ball joint according to an exemplary embodiment of the present invention.

FIG. 8 shows a flow diagram of an exemplary embodiment of a method according to the invention.

### DETAILED DESCRIPTION OF THE PREFERRED EMBODIMENTS

The following description of the preferred embodiment(s) is merely exemplary in nature and is in no way intended to limit the invention, its application, or uses.

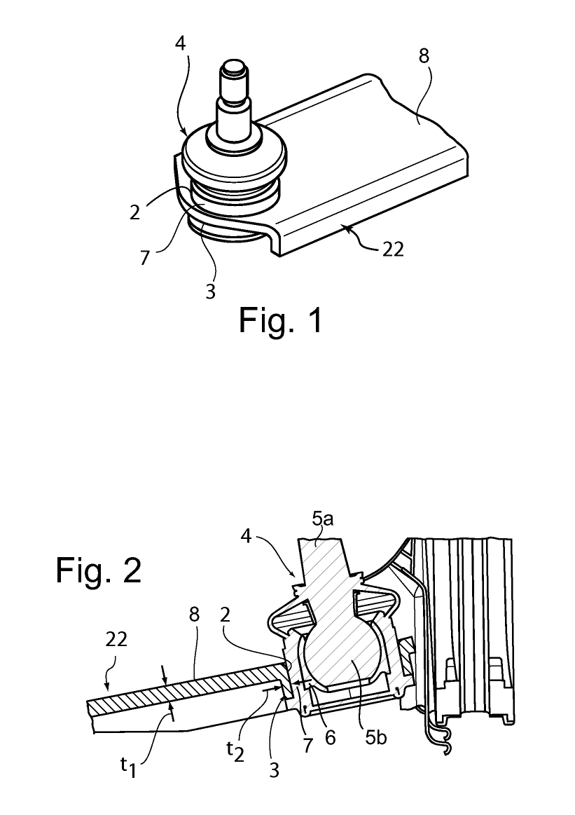

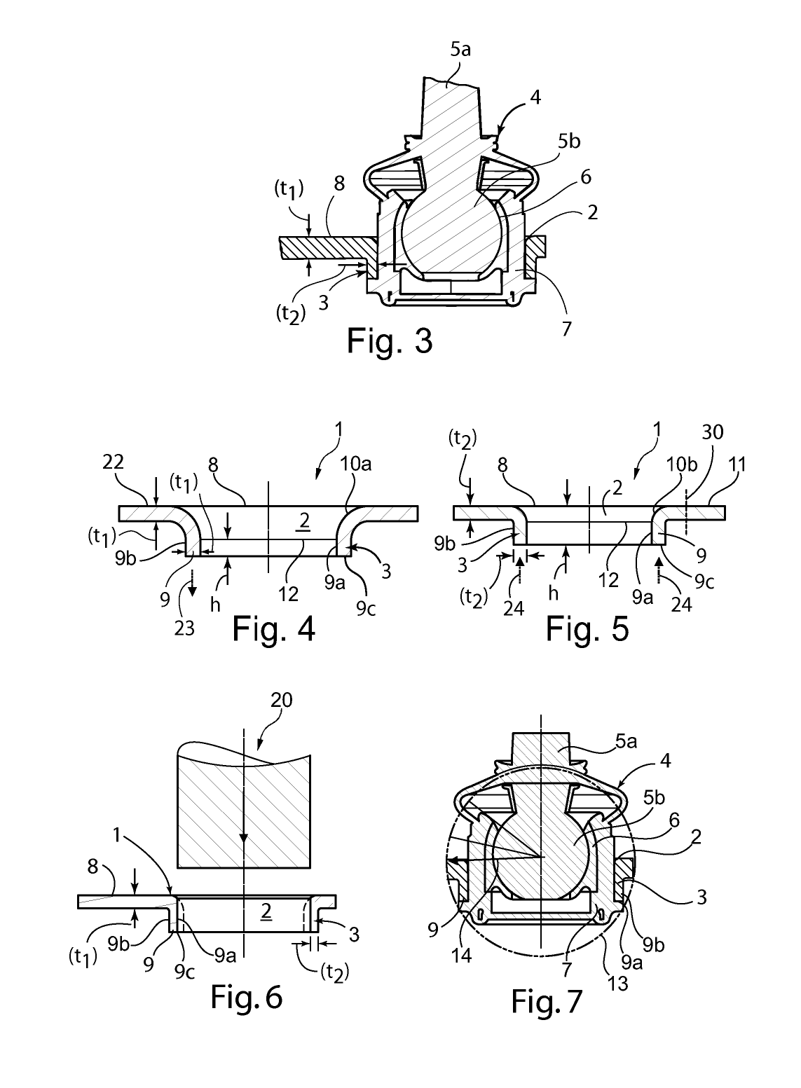

FIGS. 1-2 illustrates a control arm or transverse link 22 having a ball joint seat 1 according to an exemplary embodiment of the present invention. A ball joint 4 with joint pin 5a, ball 5b, ball shell 6 and housing 7 is press-fit into an embodiment of the ball joint seat 1 of the control arm or transverse link 22. As illustrated in the drawings, the ball joint seat 1 includes a flange 3 extending outwardly or downwardly depending from the body 8 of the control arm or transverse link 22. The flange 3 circumscribes an opening 2 of the ball joint seat 1. As illustrated, initially the flange 3 is formed integral with and of the same material as the control arm or transverse link 22; however, as set forth below, ultimately the flange 3 has a different material thickness. The term material thickness refers to the thickness of the material, preferably of the metal sheet in cross-section.

In an exemplary example, the control arm or transverse link 22 has a material thickness (t1) approximately 4mm thick. Correspondingly, the flange portion 3 has a material thickness that is, a reduced wall thickness (t2) in the region of the opening 2. The region with reduced wall thickness (t2) may also be arranged in some region other than the opening 2 of the ball joint seat 1, if the friction or press-fit contact with the ball joint 4 is realized in said corresponding region. In the exemplary embodiment, the flange portion 3 has a material thickness (t2) approximately 1 mm thick.

The starting material of the control arm or transverse link 22, and the ball joint seat 1, is preferably a metal sheet, for example a flat metal workpiece. The structure of the control arm or transverse link 22 with all necessary shapes, including that of the ball joint seat 1 for receiving the ball joint, is conventionally produced in a tool designed for carrying out all necessary machining processes. The material of the ball joint seat 1 is, in the region provided for the friction or press-fit contact with the ball joint 4, reduced by way of a cutting method such that the initial material thickness (t1) of the ball joint seat 1, that is the initial thickness (t1) of the flange 3, is reduced to a smaller or lesser material thickness (t2). The reduction in the material thickness is advantageous because it permits a press-fit connection to the ball joint 4 having a smaller outer diameter, see FIG. 7, in relation to conventional press-fit connections. In this way, the ball joint seat 1, with a smaller width or outer diameter extending to the outer edge of the control arm or transverse link 22 provides for a friction or press-fit contact with the ball joint 4 having a smaller space requirement.

Here, the material is structurally stable enough and does not lose structural integrity because of the press-fit connection, or in other words is not plastically deformed such that, under some circumstances, the functionality of the connection between control arm or transverse link 22 and wheel carrier realized by way of the ball joint seat 1 and ball joint 4 is lost. What is preferable is a control arm or transverse link 22 with a ball joint seat 1, which, in the region provided for the friction or press-fit contact with the ball joint 4, is the opening 2 of the ball joint seat 1. In this example, the opening 2 is such that region of the ball joint seat 1 in which there is close contact, which effects the friction locking of the press-fit connection, between the ball joint 4 and the ball joint seat 1.

The ball joint seat 1 includes as opening 2 sized to receive a press-fit ball joint 4. The ball joint seat 1 may be regarded as a pot-shaped housing designed to receive, by press-fitting, the ball joint 4 to form a friction or press-fit connection to the ball joint 4.

As disclosed, the control arm or transverse link 22 including the ball joint seat 1 are produced from a single piece of sheet-metal or plate. The overall structure or configuration of the control arm or transverse link 22, including the configuration of the ball joint seat 1 are produced, in part, by deformation; i.e., punching. In particular, near the ball joint seat 1, by deformation including pulling-through, plunging, deep drawing, or else in part by cutting methods such as chip removal, in that part of the ball joint seat 1 provided for the friction or press-fit contact with the ball joint 4. The forming process may be performed in one tool, in which further deformation methods, including bending, flow pressing, and extrusion may be performed.

In one example, the ball joint seat 1 can be produced as a metal-sheet rim hole formed by plunging, whereby a downwardly depending flange 3, as illustrated in FIG. 4 is obtained. Here, a pilot hole is drilled into the material of the control arm or transverse link 22 at the location of the ball joint seat 1. Proceeding from the pilot hole, the collar or flange 3 is drawn by a punch being pulled through the pilot hole in the direction of the arrow 23.

FIG. 4 shows a rounding or rounded transition region 10a formed at the transition between the horizontal plane of the surface 8 of the control arm or transverse link 22 and the inner side 9a of the wall 9 of the flange 3. As illustrated, the inner side 9a of the wall 9 is perpendicular to the surface 8 of the control arm or transverse link 22. The lower termination of the transition region 10a, as denoted by the line 12, defines the maximum height of the provided press-fit connection. The height (h) of the inner surface 9a extending between the transition line 12 and the end or bottom 9c of the wall 9 of the flange 3 defines in part the surface area of the ball joint seat 1 available for friction or press-fit contact with the ball joint 4. Understandably, the greater the surface area of the ball joint seat 1 the more secure the friction or press-fit contact with the ball joint 4.

FIG. 5 illustrates, for example, an embodiment in which the rounded transition region 10b has a radius smaller than the original transition region 10a. By virtue of the ball joint seat 1 being backward-upset, bent backward, or driven upward toward the surface 8 of the control arm or transverse link 22 by force towards the opening 2 of the ball joint seat 1 in the direction of the arrows 24 and counter to the drawing direction. The force is exerted in the direction of arrows 24 towards the opening 2 of the ball joint seat 1. The backward-upsetting may likewise be performed in the tool mentioned above. The lower termination, denoted by the line 12, of the transition region, defines the maximum height of the provided press-fit connection, which, in the case of the backward-upset variant of the ball joint seat 1, is situated closer to the plane of the surface 8 of the control arm or transverse link 22. Whereby, the height (h) of the inner surface 9a extending between the transition line 12 and the end or bottom 9c of the wall 9 of the flange 3 is increased.

The rounded transition region 10a from the substantially horizontal plane 8 of the control arm or transverse link 22 into the orientation, perpendicular thereto, of the wall 9 of the flange 3 of the ball joint seat, produced by deep drawing or in some other way, is preferably backward-upset. Bending the flange 3 backward counter to the initial downwardly depending direction of the flange 3 or rim hole by action of a force applied in the direction of arrows 24 reduces the bend radius of the ball joint seat 1. The smaller bend radius increases the maximum height of the provided press-fit connection, that is, the proximity to the opening 2 of the ball joint seat 1 or to the plane of the surface 8 of the control arm or transverse link 22. In this way, the ball joint 4 mounted in the ball joint seat 1 is closer to the wheel assembly wherein the steering offset of the motor vehicle wheel connected to the control arm or transverse link 22 is positively influenced. The upsetting of the material is also advantageous because material compaction of the ball joint seat 1 can also be effected in this way.

The reduction in material thickness (t2) of the flange 3, produced by removing material from the inside surface 9a of the flange 3, is preferably realized by chip-removing methods. Here, material is removed in relatively small amounts, by a cylindrical device, preferably a punch 20 driven or drawn through the opening 2. The punch 20 may be a plane.

FIG. 6 illustrates, by way of example, the manner producing a reduced wall thickness or width (t2) of the flange 3 of the ball joint seat 1. The original wall thickness (t1), illustrated in FIGS. 4-5, after the deformation process producing the ball joint seat 1 but before the chip-removing work, is illustrated by the dashed lines in FIG. 6. A chip-removing cylindrical device, preferably a punch 20, by sliding back and forth, or else sliding only in one direction effects a reduction in the initial material thickness (t1) proceeding from the inner side 9a. The punch 20 sliding back and forth in the opening 2 of the ball joint seat 1 removes a portion of the inner side 9a whereas the outer side 9b of the wall 9 remains unchanged. Alternatively, movement of the cylindrical device 20 in one direction for example from top to bottom is also possible. As seen in FIG. 6, the diameter of the cylindrical device 20 is slightly larger than the inner diameter of the opening 2 of the ball joint seat 1. Here, the cylindrical device 20 is inserted into the opening 2 of the ball joint seat 1 in one direction or alternately in two directions, counter to a low resistance, wherein, during each movement, small amounts of the material are removed from the inner side 9a of the wall 9 to enlarge the opening 2. The material of the flange 3 of the ball joint seat 1 is thinned, that is the initial thickness (t1) of the wall 9 of the flange 3 of the ball joint seat 1 is reduced, in stages. The amount of material removed depends on the desired final thickness (t2) of the wall 9 of the flange 3 of the ball joint seat 1, such that, altogether, a stable press-fit connection to the ball joint 4 remains possible without the ball joint seat 1 losing its structural integrity. The cylindrical device 20 is moved in the opening 2 of the ball joint seat 1 until the desired amount of material has been removed, as illustrated in FIG. 6 by the solid line. In the process, the diameter of the inner side 9a is changed. The original wall thickness (t1) is preferably approximately 4 mm, though may also be greater or smaller. Upon reduction, the thickness (t2) of the wall 9 is reduced preferably for example to 0.1 to 0.9 mm, also preferably 1.0 mm, likewise preferably 1.2 mm, likewise preferably 1.3 mm, likewise preferably 1.4 mm, likewise preferably 1.5 mm, likewise preferably 1.6 mm, likewise preferably 1.7 mm, likewise preferably 1.8 mm, likewise preferably 1.9 mm and likewise preferably 2.0 mm, and furthermore preferably up to 3.0 mm, being removed from the inner side 9a. With different initial wall thicknesses (t1) of the wall 9 of the flange 3 the removed amounts of material vary proportionately. In the disclosed example, the reduction of the initial wall thickness (t1) may be realized by a single cylindrical device 20 that removes material from the inner side 9a to realize a change and result in a final thickness (t2) from 4.0 mm to 2.0 mm. Alternatively, the initial wall thickness (t1) is reduced using different cylindrical devices 20 having different diameters.

If not required for the stability of the ball joint seat 1, and of the control arm or transverse link 22, excess outwardly protruding material 11 is removed as illustrated by the dotted line 30. For example, the material 11 of FIGS. 4-5 is removed as shown in FIGS. 6-7. The removal of the outwardly protruding material 11 is performed preferably by punching. Accordingly, in the region provided for friction or press-fit contact of the ball joint seat 1 and the ball joint 4, preferably in the region of the opening 2 of the ball joint seat 1, material protruding outward in a radial direction is advantageously severed off, see FIG. 7. By the material not required being severed off, the outer diameter defined by the arrow 14 of the ball joint seat 4, and the space requirement thereof, are further reduced.

FIG. 7 illustrates the ball joint seat 1, for example, as a press-fit seat with a press-fit ball joint. Here, the ball joint seat 1 is a tube produced by plunging and which has a reduced wall thickness (t2) in the region provided for the friction or press-fit contact with the ball joint 4 in the opening 2 of the ball joint seat 1. Here, the circle 13 denotes the radius exhibited the press-fit ball joint 4 in the ball joint seat 1. The arrow 14 denotes the distance from the center of the ball joint 4, which is identical to the center of the ball 5b, to the largest outer diameter of the ball joint seat 1. What is ideal here is an arrangement of the press-fit connection as close as possible to the wheel carrier and brake disk.

The control arm or transverse link 22 according to the invention is preferably of single-shell form. Single-shell control arms or transverse links can advantageously be produced easily and inexpensively and are distinguished by a low weight. The control arm or transverse link 22 according to the invention is preferably formed with the ball joint seat 1 as a unipartite sheet-metal element. In one example, the material of the entire control arm or transverse link 22 is cut out of a sheet-metal plate before the deformation process. It is preferably possible for the control arm or transverse link 22, after being cut out of a sheet-metal blank, which may be performed by punching, to also be deformed by punching. For the production of the ball joint seat 1 and the reduction of the material thickness (t1) of the flange 3 of the ball joint seat 1, devices for rim-hole forming or deep drawing and chip removal are however also required. Such devices may be provided in one tool. For the punching and/or for some other method for the deformation of the control arm or transverse link 22 with all structures including the ball joint seat 1, provision is therefore made of a corresponding tool designed for producing the structures of the control arm or transverse link 22.

The control arm or transverse link 22 includes a ball joint 4 press-fit into the ball joint seat 1. The ball joint 4 is, by way of its housing 7, surrounded by a support structure, in the preferred example a flange 3 of the ball joint seat 1 that fixedly connects the ball joint 4 to the control arm or transverse link 22 by friction or press-fit locking. Whereby the press-fit ball joint 4 and the control arm or transverse link 22 can be connected to a wheel bearing of a motor vehicle. Further, the material of the ball joint seat 1 has a reduction in material thickness (t2), in the region provided for friction or press-fit contact with the ball joint 4, in particular in the region of the opening 2 of the ball joint seat 1.

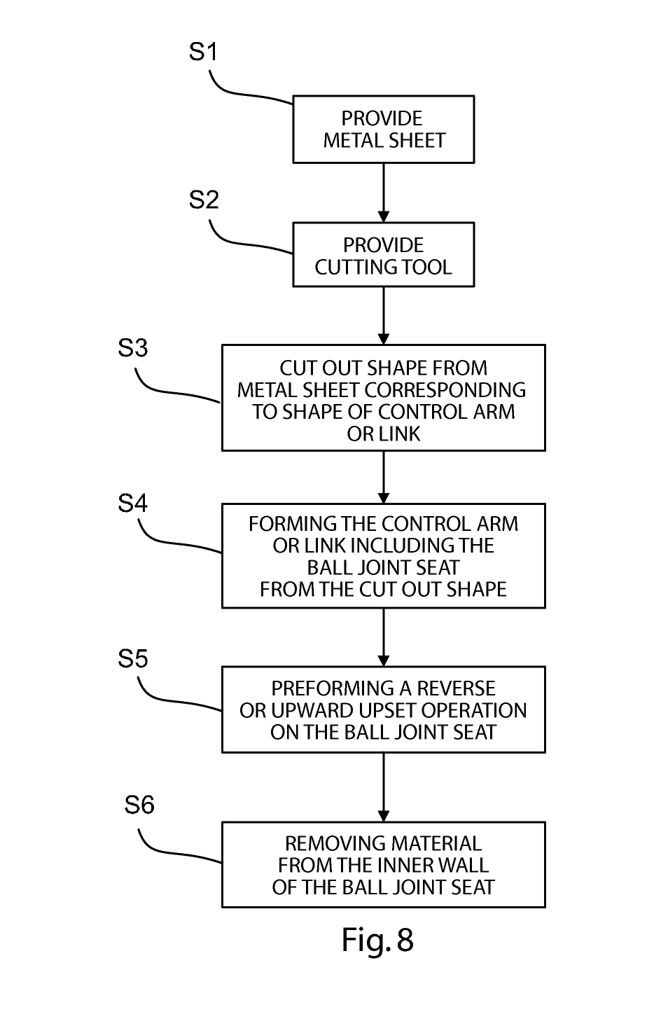

FIG. 8 illustrates an exemplary embodiment of the method for forming the ball joint seat 1. In step 51, a metal sheet is provided as a starting material. The metal sheet has a material thickness (t1). In step S2, a tool for cutting and for deforming the metal sheet is provided. The tool is preferably designed for punching, or other deformation methods, for example bending, flow pressing, extrusion, pulling-through, deep drawing and plunging. Furthermore, severing methods, for example chip removal, can also be performed by the same tool. The stated methods, and other methods, may be combined with one another. The tool may also be a progressive tool. Certain steps may however also be performed outside the tool, for example the chip-removal process and another tool provided for that purpose.

In a further step S3, a shape corresponding to the basic shape of the control arm or transverse link 22 is cut out of the metal sheet. The dimensions of the cut out shape, also referred to as a blank, are configured such that all regions to be deformed, and all regions which are not to be deformed, of the transverse link are encompassed in the cut out shape or blank. The blank is cut out of the metal sheet preferably by punching.

In step S4, the blank or the metal sheet is deformed in the tool to form a control arm or transverse link 22 with all link elements and having the ball joint seat 1 for receiving the ball joint 4. Here, the ball joint seat 1 including the flange 3 is formed preferably by plunging. Alternatively, the ball joint seat 1 may be formed for example by deep drawing. As shown, initially the flange 3 has a material thickness (t1) the same as the metal sheet.

In step S5, the material of the ball joint seat 1, in particular in the rounded transition region 10a of the ball joint seat 1, from a horizontal plane 8 of the surface of the control arm or transverse link 22 to the inner side 9a arranged perpendicular thereto, of the wall 9 of the ball joint seat 1, is upset backward. For this purpose, the transition region 10a is bent backward by action of force in the direction of the arrows 24 towards the opening 2 of the ball joint seat 1. Such backward-upsetting may likewise be performed in the tool mentioned above. In the process, the radius of the transition region 10a is reduced to the radius of the backward-upset transition region 10b.

In step S6, movement of the cylindrical device 20 in the opening 2 of the ball joint seat 1 removes material, in the form of chips, from the inner side 9a of the wall 9 of flange 3 of the ball joint seat 1. This step continues until a desired increase of the inner diameter of the opening 2 of the ball joint seat 1 is obtained. Increasing the inner diameter of the opening 2 correspondingly decreases the initial material thickness (t1) of the flange 3. Step S6 may also be performed before step S5.

The method according to the invention is advantageous because reducing the initial material thickness (t1) to a reduced material thickness (t2) correspondingly reduces the outer diameter of the ball joint seat 1 as compared with conventional seats. The reduced outer diameter yields a smaller space requirement of the press-fit connection of the ball joint 4 to the ball joint seat 1. The outer diameter of the ball joint seat refers to the width or the outer dimensions of the wall 9 of the flange 3 of the ball joint seat 1 having the press-fit ball joint 4 as illustrated by arrow 14 of FIG. 7.

One example includes a single-shell control arm or transverse link 22 produced in the method according to the invention. The production of single-shell control arms or transverse links 22 is advantageously inexpensive, and single-shell control arms or transverse links 22 are of simple but stable structure and are distinguished by a low weight.

The starting material of the transverse link, and also of the ball joint seat 1, is preferably a metal sheet, for example a flat metal workpiece. The starting material is a so-called sheet-metal coil on which the metal sheet is wound up. A shape corresponding to the basic shape of the control arm or transverse link 22, a so-called blank, is cut from the metal sheet. The link elements of the control arm or transverse link 22 are in this case all elements typically exhibited by a link, in particular a control arm or transverse link 22, for example track rods, support arms, fastening devices and the like. The control arm or transverse link 22 and the ball joint seat are produced as a unipartite sheet-metal element in the method according to the invention.

In the method according to the invention, the region provided for friction or press-fit contact with the ball joint 4 is preferably the opening 2 of the ball joint seat 1. The reduction in the material thickness (t2) of the wall 9 is produced in the region of the opening 2 of the ball joint seat 1. The reduction of the wall thickness (t2) may however also be produced in some other region of the ball joint seat 1 if the friction or press-fit contact with the ball joint 4 is to be realized there.

The ball joint seat 1 is preferably formed by a drawing punch being pulled through the material of the control arm or transverse link 22. A so-called metal-sheet rim hole is formed in this way. This method is also referred to as plunging. A further possibility for forming the means is deep drawing. The wall thickness (t2) of the ball joint seat is preferably reduced by chip removal, that is material being removed from the inner side 9a of the wall 9 of the flange 3 of the ball joint seat 1. Here, small material parts (chips) are removed from the surface of the inner side 9a. Chip removal can, by way of comparison, be conceived as a form of planing.

Severing of the material of the control arm or transverse link 22 or ball joint seat 1 is preferably performed by way of a cylindrical device, in particular a punch. Here, it is advantageous if a chip-removing region of the cylindrical device is of circular cylindrical form. The circular cylindrical form makes it possible for material to be removed from the inner side 9a of the wall 9 uniformly from all sides.

The diameter of the cylindrical device, in particular of the chip-removing region, is greater than the inner diameter of the opening or hole 2. The size difference is slight, such that the cylindrical device can still slide in the opening 2, wherein said cylindrical device removes correspondingly small amounts of material from the inner side 9a of the wall 9. Cylindrical devices with different, progressively larger diameters may be used in accordance with the increasing inner diameter of the opening 2.

The method may include an additional step of backward-upsetting the transition region of the press-fit ball joint seat 1 from the horizontal plane 8 of the surface of the control arm or transverse link 22 to the inner side 9a arranged perpendicular thereto of the wall 9 of the flange 3 of the ball joint seat 1. As illustrated, the rounded transition region 10a is bent backward by action of a force counter to the direction of the opening 2. In this way, the radius of the rounded transition region 10a of the ball joint seat is reduced. The smaller bend radius 10b increases the overall height of the area for the press-fit connection, that is to say the proximity to the opening 2 of the ball joint seat to the plane of the surface 8 of the control arm or transverse link 22, is displaced. In this way, the ball joint 4 is closer to the end of the control arm or transverse link 22 and the steering offset of the motor vehicle wheel connected to thereto is positively influenced. The upsetting of the material is also advantageous because material compaction of the press-fit seat is also effected in this way.

Further, material in those regions of the ball joint seat situated to the outside of the opening 2 in a radial direction is removed, see material 11 extending past dotted line 30. Specifically the furthest extending portion of the ball joint section 2. By removing material not required, the outer diameter of the ball joint seat, and thus the space requirement thereof, is advantageously reduced.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle suspension member comprising:
a link having a material thickness and a ball joint seat;
said ball joint seat having a flange, said flange including a wall having an inner side, said inner side in contact with a ball joint; and
said flange having a material thickness, said material thickness being smaller than said material thickness of said link.

2. The suspension member of claim 1 wherein the material thickness of said flange is less than half that of said material thickness of said material thickness of said link.

3. The suspension member of claim 1 wherein the inner side of said flange in contact with said ball joint is in the form of a press-fit seat.

4. The suspension member of claim 1 wherein the material thickness of said flange extends longitudinally along said flange in that area wherein said inner side of said flange contacts said ball joint.

5. The suspension member of claim 1 being a one-piece construction, wherein said link and said flange integrally formed from a single material.

6. The suspension member of claim 1 wherein said flange is a continuous part of and an extension of said link.

7. The suspension member of claim 1 wherein material protruding outwardly in the radial direction in the region of an opening of the ball joint seat is severed off.

8. The suspension member of claim 1 wherein said link is a single-shell member.

9. The suspension member of claim 1 wherein said ball joint (4) is press-fit into said ball joint seat.

10. A method for producing suspension member of the motor vehicle comprising the steps of:
providing a metal sheet having an initial material thickness;
providing a tool for cutting and deforming the metal sheet;
cutting a shape corresponding to the basic shape of the suspension member from the metal sheet;
deforming the cut-out metal sheet to form the suspension member;
forming a ball joint seat in the suspension member, said ball joint seat including a flange, and
removing material from an inner side of a wall of the flange in a region provided for press-fit contact with a ball joint.

11. The method of claim 1 including the step of producing the suspension member in single-shell form.

12. The method of claim 1 including the step of producing the suspension member as a unipartite sheet-metal element.

13. The method of claim 1 wherein the region provided for the press-fit with the ball joint extends longitudinally along the inner side of said flange.

14. The method of claim 1 wherein the step of forming the ball joint seat includes a draw process.

15. The method of claim 1 wherein said material is removed from the inner wall of said flange using a chip removal process.

16. The method of claim 1 wherein said material is removed from the inner wall of said flange using a cylindrical device.

17. The method of claim 1 including the step of backward-upsetting a transition region of the ball joint seat in a direction transverse a horizontal plane of a surface of the suspension member.

18. The method of claim 1 including the step of removing a region of the ball joint seat situated outside an opening of said ball joint seat in a radial direction.
